(19) United States
(12) Patent Application Publication
(10) Pub. No.: US 2004/0266452 A1
(43) Pub. Date: Dec. 30, 2004

(54) Apparatus for transmitting signals between ultra wideband networks

(76) Inventors: Seo-Won Kwon, Suwon-shi (KR); Yun-Kyung Oh, Seoul (KR); Sang-Il Lee, Seoul (KR); Jong-Hun Lee, Suwon-shi (KR); Jong-Hwa Lee, Suwon-shi (KR)

Correspondence Address: CHA & REITER, LLC, 210 ROUTE 4 EAST STE 103, PARAMUS, NJ, 07652, US

(21) Appl. No.: 10/681,936

(22) Filed: Oct. 9, 2003

(30) Foreign Application Priority Data
Jun. 9, 2003 (KR) 2003-36729

(51) Int. Cl. H04Q 7/20

(52) U.S. Cl. 455/454

(57) ABSTRACT

An apparatus for transmitting signals between UWB networks is disclosed, which comprises: a signal converter for converting received optical signals from another UWB network into UWB signals, transmitting the converted optical signals within a UWB network, and converting UWB signals generated from within the UWB network into optical signals; and an optical signal transmission means for directing the received optical signals the signal converter and a further UWB network.

### CLAIM OF PRIORITY

This application claims priority to an application entitled “Apparatus for transmitting signals between ultra wideband networks,” filed in the Korean Intellectual Property Office on Jun. 9, 2003 and assigned Serial No. 2003-36729, the contents of which are hereby incorporated by reference.

### BACKGROUND OF THE INVENTION

1. Field of the Invention

The present invention relates to an apparatus for transmitting signals between ultra wideband networks, and more particularly to an apparatus for converting ultra wideband (hereinafter, referred to as ‘UWB’) signals into optical signals and transmitting the converted signals between UWB networks.

2. Description of the Related Art

An UWB transmission is radio transmission technology that has an occupied bandwidth of at least 500 MHz or taking at least 20% of a central frequency. The UWB transmission and Millimeter Wave (MMW) transmission are the only known technologies capable of supporting radio transmissions at speeds more than 100 Mbps. However, the transmission distance of UWB signals, at transmission speeds more than 100 Mbps, decreases relatively to less than 10 m. As shown in FIG. 1, UWB have been applied to a picocell (within 10 m), but expanding the transmission distance using the UWB has not been pursued.

Referring to FIG. 1, both a picocell1 10 and a picocell1 20 are within 10 m. Communication between terminals STA1 11, STA2 12, STA3 13 and STA4 14, or STA5 21, STA6 22, STA7 23 and STA8 24 in each cell is possible, but not outside of each cell. For example, UWB signals can be transmitted/received between the STA1 11 and the STA2 12 existing in the picocell1 10. However, UWB signals can't be transmitted/received between the STA1 11 existing in the picocell1 10 and the STA7 23 existing in the picocell2 20.

In such UWB signals, since the transmission distance limited, the application range is also limited.

### SUMMARY OF THE INVENTION

Accordingly, the present invention has been made to reduce overcome the above-mentioned problems occurring in the prior art. One object of the present invention is to provide an apparatus capable of expanding the transmission distance of UWB signals. An other object of the present invention is to provide an apparatus for transmitting UWB signals between UWB networks. Still another object of the present invention is to provide an apparatus for expanding an application range of UWB signals.

In accordance with the principles of the present invention, an apparatus for transmitting signals between UWB networks is provided and includes a signal converter for converting received optical signals from another UWB network into UWB signals, transmitting the converted optical signals within a UWB network, a nd converting UWB signals generated from within the UWB network into optical signals; and an optical signal transmission means for directing the received optical signals the signal converter and a further UWB network.

### BRIEF DESCRIPTION OF THE DRAWINGS

The present invention will be more apparent from the following detailed description taken in conjunction with the accompanying drawings, in which:

FIG. 1 is a diagram of a communication area in a conventional ultra wideband network;

FIG. 2 is a block diagram of an apparatus for transmitting signals between UWB networks according to an embodiment of the present invention;

FIG. 3 is a diagram of a data format of signals transmitted between UWB networks according to an embodiment of the present invention; and

FIG. 4 is a diagram of a system for transmitting signals between UWB networks according to an embodiment of the present invention.

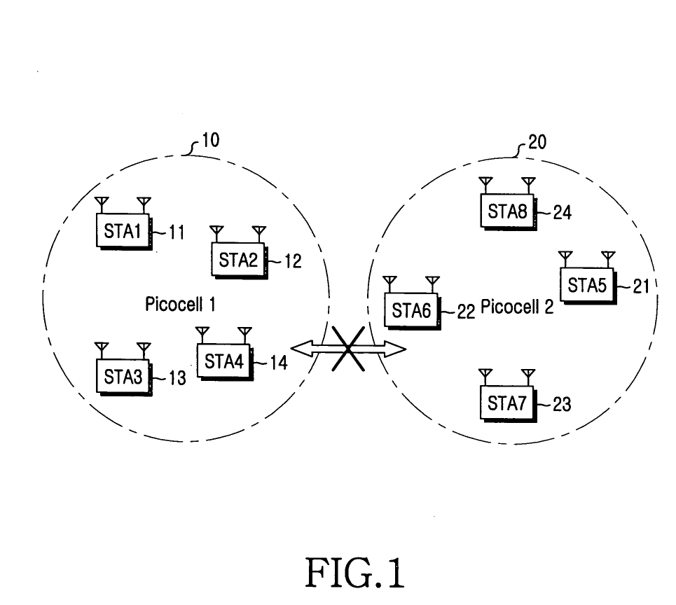

### DETAILED DESCRIPTION OF THE PREFERRED EMBODIMENT

A preferred embodiment according to the present invention will be described with reference to the accompanying drawings. For the purposes of clarity and simplicity, well-known functions or constructions are not described in detail since they would obscure the invention in unnecessary detail.

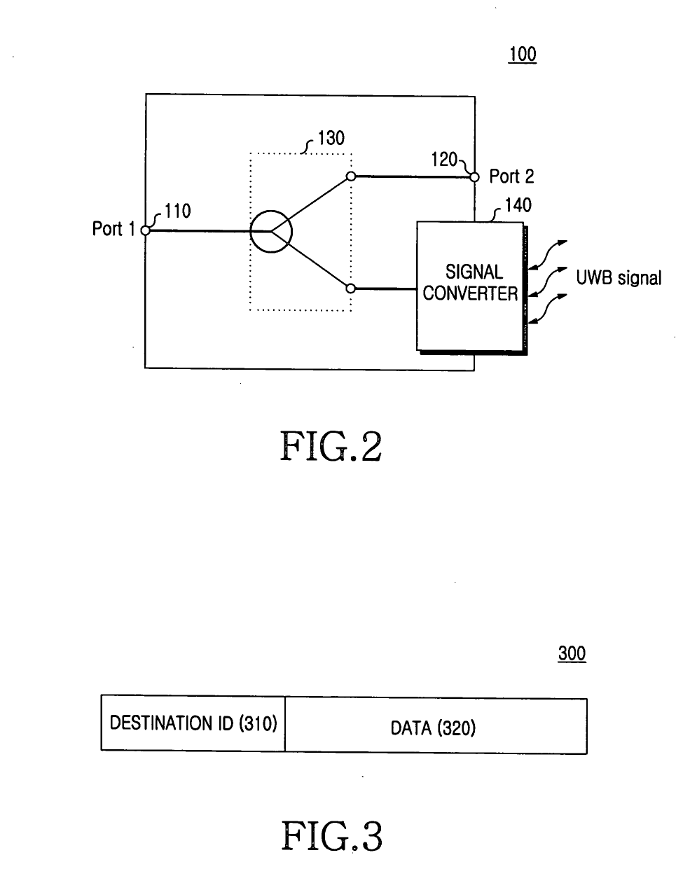

FIG. 2 is a diagram of an apparatus 100 for transmitting signals between UWB networks according to an embodiment of the present invention. Referring to FIG. 2, the apparatus 100 according to an embodiment of the present invention includes a first port 110, a second port 120, an optical signal transmission means 130 and a signal converter 140.

The first port 110 receives optical signals from other UWB networks. The second port 120 transmits optical signals to other UWB networks.

The signal converter 140 converts optical signals into UWB signals and transmits the converted signals within a UWB network. Further, the signal converter 140 converts UWB signals generated within the UWB network into optical signals. As those skilled in the art will recognize, the conversion between the optical signal and the UWB signal may be performed by various methods and the conversion methods are not limited in the present invention.

The optical signal transmission means 130 transmits the optical signals received through the first port 110 to the signal converter 140 and the second port 120. The optical signal transmission means 130 may include (may be constructed by) either photocouplers or optical switches. The photocouplers distribute inputted signals and transmit the distributed signals. The optical switches transmit inputted signals to the signal converter 140 or the second port 120

The optical signal transmission means 130 stores (in for example a controller, not shown) a predetermined identification numbers in advance in order to control the switches, when optical switches are used. The optical signal transmission means 130 transmits a corresponding optical signal to the signal converter 140 only when a destination ID of the inputted optical signal corresponds to or is equal to the its own identification number. Otherwise, when the destination ID of the inputted optical signal is not equal to the its own identification number, the optical signal transmission means 130 transmits a corresponding optical signal to the second port 120.

FIG. 3 is a diagram of a data format 300 of signals transmitted between UWB networks according to an embodiment of the present invention. Referring to FIG. 3, signals transmitted between UWB networks include a destination ID area 310 and a data area 320. Accordingly, when the present invention receives such signals, the optical signal transmission means 130 (having optical switches) compares destination IDs included in the received signals with its own identification numbers. When the destination IDs are equal to its own identification numbers, the optical signal transmission means 130 transmits the received signals to a signal converter in a corresponding UWB network.

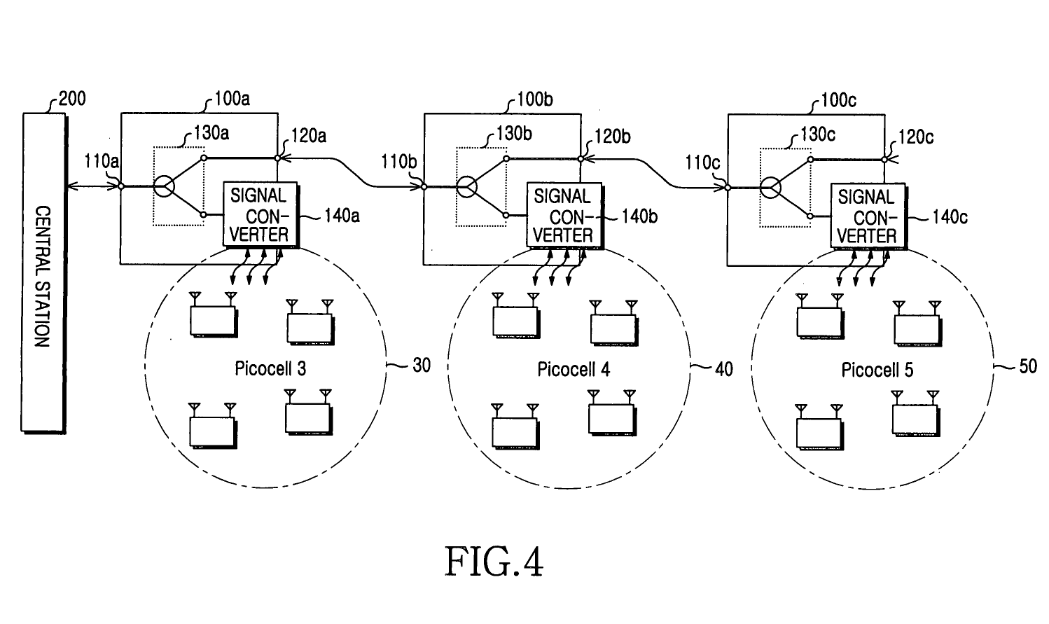

FIG. 4 is a diagram of a system for transmitting signals between UWB networks according to an embodiment of the present invention. An UWB network is expressed as a picocell in FIG. 4.

Referring to FIG. 4, picocells picocell3 30, picocell4 40 and picocell5 50 are connected through signal transmission apparatuses 100a, 100b and 100c between UWB networks as shown in FIG. 4. For example, the picocell3 30 is connected to the picocell4 40 through a second port 120a of the signal transmission apparatus 100a between UWB network and a first port 110b of the signal transmission apparatus 100b between UWB network. Further, the picocell4 40 is connected to the picocell5 50 through a second port 120b of the signal transmission apparatus 100b between UWB network and a first port 110c of the signal transmission apparatus 100c between UWB network.

In addition, signal transmission between UWB networks includes a downstream transmission and an upstream transmission In the downstream transmission a central station 200 transmits signals to each of picocells 30, 40 and 50. In the upstream transmission each of the picocells 30, 40 and 50 transmits signals to the central station 200

Regarding the downstream transmission, when photocouplers are used (in the optical signal transmission means 130a, 130b and 130c in the signal transmission apparatuses 100a, 100b and 100c between UWB networks) data that is output from the central station 200 is first divided by the optical signal transmission means 130a in the signal transmission apparatus 100a. A portion of the divided data is converted into an UWB signal and is transmitted to the picocell3 30. Another portion of the other divided data is transmitted to the signal transmission apparatus 100b between UWB networks through the second port 120a of the signal transmission apparatus 100a between UWB networks. Further, optical signals received through the first port 110b of the signal transmission apparatus 100b between UWB networks is further divided by the optical signal transmission means 130b in the signal transmission apparatus 100a. A portion of the divided signals are converted into UWB signals and are transmitted to the picocell4 40. Another portion of the other divided signals are transmitted to the signal transmission apparatus 100c between UWB networks through the second port 120b of the signal transmission apparatus 100b between UWB networks. Advantageously, the transmission distance of the UWB signals is expanded, since data is transmitted from the central station 200 to the plurality of picocells by passing through the plurality of signal transmission apparatuses between UWB network.

Furthermore, in downstream transmission, when optical switches are used (in the optical signal transmission means 130a, 130b and 130c in the signal transmission apparatuses 100a, 100b and 100c between UWB networks) the optical signal transmission means 130a, 130b and 130c determine whether data with destination information output from the central station 200 will be received by a corresponding picocell or will be transmitted to a next picocell. As a result of the determination, (1) the optical signal transmission means 130a transmit the data to one of signal converters 140a and the second ports 120a, (2) the optical signal transmission means 130b transmit the data to one of signal converters 140b and the second ports 120b, and (3) the optical signal transmission means 130c transmit the data to one of signal converters 140c and the second ports 120c. Advantageously, when data security is required, this method is preferred, since data output from the central station 200 is transmitted to one picocell at a time.

Regarding upstream transmission, when a random UWB terminal outputs UWB signals, a signal transmission apparatus between UWB networks in a corresponding cell sends the data upward to the central station side.

For example, when a UWB terminal included in the picocell4 40 outputs UWB signals, the signal converters 140b converts the UWB signals into optical signals and transmits the converted optical signals to the optical signal transmission means 130b. The optical signal transmission means 130b outputs the received optical signals through the first port 110b. Then, the signal transmission apparatuses 100a between UWB network transmits corresponding optical signals to the central station 200 via the second port 120a, the optical signal transmission means 130a and the first port 110a.

In addition to the method described above, passive switching may be performed for the switching operation in the optical signal transmission means., In particular, sensors may be utilized, or a CSMA/CA method according to communication between UWB terminals in each picocell and a signal transmission apparatus between UWB networks may be employed. Further, switching in each module may competitively occur between different picocells. Then, the central station may operate a switch in each module in a TDM method or may control the switch by using a proper protocol such as a CSMA/CA method. Thus, solving the problem of competitively occurring between picocells different from each other. According to an application of such a protocol, a network type and a service field may be changed. In the present invention, a setting regarding such switching operation and protocol is not performed.

In a signal transmission apparatus between UWB networks according to the present invention as described above, UWB signals are converted into optical signals and the converted optical signals are transmitted. In this manner, the UWB signals are transmitted without the distance limitation of the prior art. Moreover, for downstream transmission, an optical switch structure can be applied to the signal transmission apparatus between UWB networks according to the present invention. This optical switch structure enables the selection of service areas by hardware, thereby providing and enhanced security environment. Furthermore, the signal transmission apparatus service is easily expanded by simply connecting it to a port of the nearest module. For example, when an error occurs or the signal transmission apparatus is temporarily congested.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for transmitting signals between UWB networks, comprising:
a signal converter for converting received optical signals from another UWB network into UWB signals, transmitting the converted optical signals within a UWB network, and converting UWB signals generated from within the UWB network into optical signals; and
an optical signal transmission means for directing the received optical signals the signal converter and a further UWB network.

2. The apparatus as claimed in claim 1, further including a first port for receiving optical signals from the other UWB networks.

3. The apparatus as claimed in claim 1, further including a second port for outputting the optical signals to other UWB networks.

4. The apparatus as claimed in claim 1, wherein the optical signal transmission means is a photocoupler.

5. An apparatus for transmitting signals between UWB networks, comprising:
an optical switch for transmitting received optical signals from an other UWB network to a signal converter and an output port to further UWB networks, wherein the signal converter converts the received optical signals into UWB signals, transmits the converted optical signals within a UWB network, and converts UWB signals generated within the UWB network into optical signals.

6. The apparatus as claimed in claim 5, wherein the optical switch includes a controller.

7. The apparatus as claimed in claim 5, wherein the optical switch stores a predetermined identification number and transmits the received optical signal to the signal converter only when a destination identification number in the received optical signal corresponds to the predetermined identification number.

8. The apparatus as claimed in claim 5, wherein the optical switch is a passive device.

9. The apparatus as claimed in claim 8, wherein the optical switch further includes sensors.

10. The apparatus as claimed in claim 8, wherein the optical switch further includes a CSMA/CA method
